(19) United States
(12) Patent Application Publication
(10) Pub. No.: US 2011/0198063 A1
(43) Pub. Date: Aug. 18, 2011

(54) TUBULAR HEAT EXCHANGER, AND METHOD OF PRODUCING A TUBULAR HEAT EXCHANGER

(75) Inventor: HELMUT MEYER, Ratingen (DE)

(73) Assignee: POLYTETRA GmbH, Monchengladbach (DE)

(21) Appl. No.: 13/026,808

(22) Filed: Feb. 14, 2011

Related U.S. Application Data
(60) Provisional application No. 61/307,611, filed on Feb. 24, 2010.

(30) Foreign Application Priority Data
Feb. 15, 2010 (DE) 10 2010 000 421.9
Feb. 15, 2010 (DE) 20 2010 000 189.7

(51) Int. Cl. F28F 19/00; F28D 7/10; B23P 15/26

(52) U.S. Cl. 165/119; 165/154; 29/890.053

(57) ABSTRACT

A tubular heat exchanger includes a substantially cylindrical sheathing tube having a center piece and two end pieces of a length which is shorter than a length of the center piece. Two perforated bases are respectively received in the end pieces and sized to occupy a cross section thereof, and two end caps are respectively secured to axial ends of the end pieces. Extending in substantial parallel relationship inside the sheathing tube between the perforated bases are a plurality of internal tubes to thereby define a first fluid space between an inner surface of the sheathing tube and outer surfaces of the internal tubes, and a separate second fluid space bounded by inner surfaces of the internal tubes and the end caps on the end pieces. A lateral connection pipe is secured to each end piece and fluidly communicates with the first fluid space in a region adjacent to the perforated bases for supply and drainage, respectively, of a first fluid flowing through the first fluid space. The end pieces constitute separate parts which are welded with their axial ends to opposite ends of the center piece and to the end caps.

### CROSS-REFERENCES TO RELATED APPLICATIONS

This application claims the benefit of prior filed U.S. provisional Application No. 61/307,611, filed Feb. 24, 2010, pursuant to 35 U.S.C. 119(e), the content of which is incorporated herein by reference in its entirety as if fully set forth herein.

This application also claims the priority of German Patent Applications, Serial Nos. 10 2010 000 421.9, filed Feb. 15, 2010, and 20 2010 000 189.7, filed Feb. 15, 2010, pursuant to 35 U.S.C. 119(a)-(d), the contents of which are incorporated herein by reference in its entirety as if fully set forth herein.

### BACKGROUND OF THE INVENTION

The present invention relates, in general, to the field of tubular heat exchangers.

The following discussion of related art is provided to assist the reader in understanding the advantages of the invention, and is not to be construed as an admission that this related art is prior art to this invention.

In conventional tubular heat exchangers of plastic a first fluid, which normally serves as liquid and/or gaseous cooling or heating medium for a second fluid which is a liquid and/or gaseous cooling or heating medium to be cooled or heated, enters through a connection pipe and directly impacts part of the internal tubes or hoses. As a result, these areas are exposed to intense mechanical stress by the incoming fluid and thus wear off quickly.

One approach to address this problem involves the use of a lateral connecting ring to prevent the first fluid from directly impacting the internal hoses but rather to route the first fluid around a sheathing tube and to incrementally introduce it from there. FIG. 4 shows a tubular heat exchanger having such a lateral connecting ring 4 which is welded onto a sheathing tube 2 and has a circumference of U-shaped cross section which opens radially inwards towards the sheathing tube 2 so as to establish a ring-shaped passage 6 around the sheathing tube 2. In the area of a part of this passage 6, the sheathing tube 2 has a number of small holes 8 across which the fluid flow into the first fluid space in the sheathing tube disperses. The presence of such holes causes a mechanical weakening of the sheathing tube 2. Moreover, because of the positioning of the required weld seam, the lateral connecting ring 4 cannot be connected to the sheathing tube 2 by contactless infrared welding process which is a preferred welding process for manufacturing tubular heat exchangers because of its reliability. Therefore, the connection between the lateral connecting ring 4 to the sheathing tube is therefore realized by high speed hot gas welding which however is less reliable so that, e.g., a sealing of the passage 6 at the welded connection between the sheathing tube 2 and the lateral connecting ring 4 cannot be ensured.

It would therefore be desirable and advantageous to provide an improved tubular heat exchanger to obviate prior art shortcomings and to exhibit high pressure resistance and reliability as well as a long service life

### SUMMARY OF THE INVENTION

According to one aspect of the present invention, a tubular heat exchanger includes a substantially cylindrical sheathing tube having a center piece and two end pieces of a length which is shorter than a length of the center piece, two perforated bases received in the end pieces in one-to-one correspondence and sized to occupy a cross section thereof, two end caps secured to axial ends of the end pieces in one-to-one correspondence, a plurality of internal tubes extending in substantial parallel relationship inside the sheathing tube between the perforated bases to thereby define a first fluid space between an inner surface of the sheathing tube and outer surfaces of the internal tubes, and a separate second fluid space bounded by inner surfaces of the internal tubes and the end caps on the end pieces, and two lateral connection pipes secured to the end pieces in one-to-one correspondence and fluidly communicating with the first fluid space in a region adjacent to the perforated bases for supply and drainage, respectively, of a first fluid flowing through the first fluid space, wherein the end pieces constitute separate parts which are welded with their axial ends to opposite ends of the center piece and to the end caps.

As the sheathing tube is now produced not from a single tube but separately from a center piece and two end pieces which are only subsequently welded together, the freedom in designing the end pieces is significantly enhanced compared to a single tube that has been simply cut from a tubular section. For example, it is possible to manufacture the end pieces at least partway of greater outer diameter and/or greater wall thickness than the center piece of the sheathing tube. This gains space to shape and install fluid guide structures which at least in part disperse fluid incoming from the connection pipe across the circumference of the end piece or collect fluid outflowing from there through the connection pipe, so that mechanical stress on the internal tubes or hoses is reduced in this region and the service life is increased. The greater outer diameter and/or greater wall thickness also permits the provision of such fluid guide structures without adversely affecting stability. Furthermore, the end pieces can be welded with the sheathing tube by the reliable contactless infrared welding process. As a result, all requirements as far as pressure resistance, reliability, and service life are concerned can be met.

Suitable fluid guide structures can be realized in a simple manner by widening the cross section of the inflow and outflow ports in the area of the ends of the first fluid space adjacent to the perforated bases. As an alternative or in addition, various fluid deflection structures can be provided, e.g. in the form of a baffle plate to cover at least part of the inner cross section of the respective connection pipe. Such a baffle plate may be made from an elongated rectangular plastic board which is bent along its length into a part circle with a radius that is smaller than the radius of the end piece. This baffle plate can easily be secured to the end piece by forming protrusions along their longitudinal edges for engagement into bent retention grooves formed in the end piece in the area of the connection pipe.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a perspective view of a tubular heat exchanger with a sheathing tube comprised of a center piece and two end pieces in accordance with a first exemplary embodiment;

FIG. 1b is a longitudinal sectional view of one end of the heat exchanger shown in FIG. 1a, taken along the line A-A in FIG. 1c;

FIG. 1c is a plan view of the heat exchanger shown in FIG. 1a, as viewed from its axis;

FIG. 1d is a plan view of the end of the heat exchanger shown in FIG. 1b, as viewed from the connection pipe thereof;

FIG. 1e is a cross sectional view of the heat exchanger shown in FIG. 1a, taken along the line B-B in FIG. 1d;

FIG. 2a is a perspective view, on an enlarged scale compared to FIGS. 1a to 1e, of one of the substantially cylindrical end pieces of the heat exchanger shown in FIGS. 1a to 1e;

FIG. 2b is a cross sectional view of the end piece of the heat exchanger, shown in FIG. 2a, taken along the line B-B in FIG. 2c;

FIG. 2c is an axial plan view of the end piece of the heat exchanger, shown in FIG. 2a;

FIG. 2d is a cross sectional view of the end piece of the heat exchanger, shown in FIG. 2a, taken along the line A-A in FIG. 2c;

FIG. 3a is an axial plan view of an end piece of a heat exchanger in accordance with a second exemplary embodiment;

FIG. 3b is a longitudinal sectional view of the end piece of the heat exchanger, shown in FIG. 3a, taken along the line A-A in FIG. 3a;

FIG. 4 is a longitudinal sectional view of one end of a conventional tubular heat exchanger with lateral connecting ring and perforated sheathing tube;

FIG. 5a is an axial plan view of an end piece of a tubular heat exchanger in accordance with a third exemplary embodiment;

FIG. 5b is a longitudinal sectional view of the end piece of the heat exchanger, shown in FIG. 5a, taken along the line A-A in FIG. 5a;

FIG. 6a is an axial plan view of an end piece of a tubular heat exchanger in accordance with a fourth exemplary embodiment; and

FIG. 6b is a longitudinal sectional view of the end piece of the tubular heat exchanger, shown in FIG. 6a, taken along the line A-A in FIG. 6a.

### DETAILED DESCRIPTION OF PREFERRED EMBODIMENTS

Throughout all the figures same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

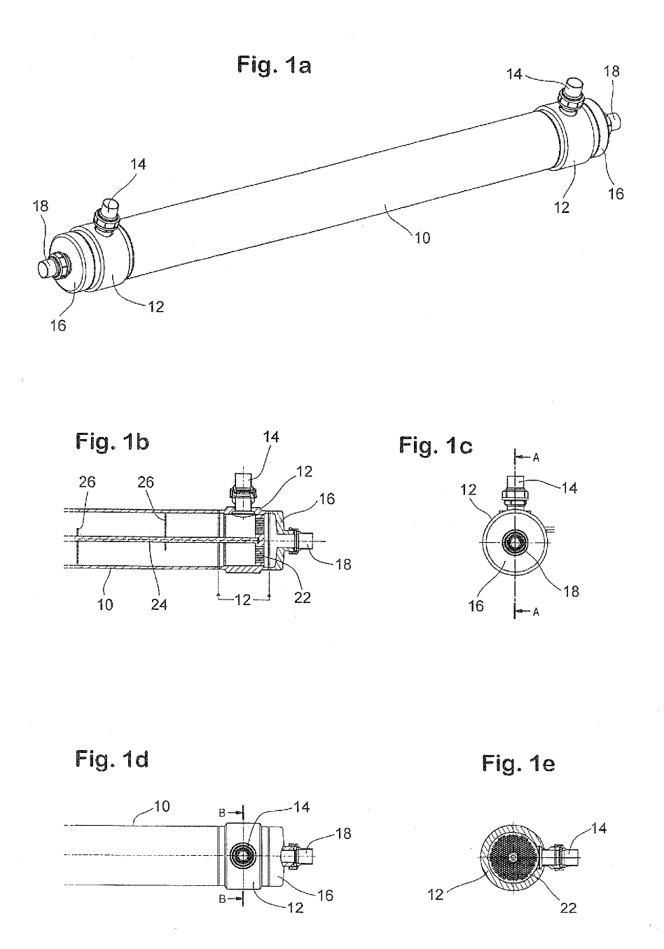

A tubular heat exchanger in accordance with the present invention is shown in FIGS. 1a to 1e and made entirely of a plastic such as, e.g., PFA, ECTFE, PVDF, PP, or PE. The heat exchanger shown here has a length of approx. three meters; it may, however, also have other dimensions.

A sheathing tube of the heat exchanger includes a longer cylindrical center piece 10 and two shorter cylindrical end pieces 12 which are welded axially aligned to the center piece 10. A connection pipe 14 is welded to or formed on the circumference of each end piece 12 and projects vertically there from. Welded to the outer edges of the end pieces 12 are end caps 16, each of which having welded thereto or formed thereon an axially aligned connection pipe 18, although as an alternative the connection pipe may also project out to the side. All afore-mentioned welded connections are implemented in a fluid-tight manner.

A perforated base 22 is welded in the axially outer end of each end piece 12 and has the shape of a disk which extends perpendicular to the axis of the sheathing tube and occupies the entire cross section of the end piece 12. The perforated base 22 includes a great number of small holes which extend at small distances in spaced-apart parallel relationship to one another and to the axis of the sheathing tube.

A retention rod 24 extends along the axis of the sheathing tube from one perforated base 22 to the other. The retention rod 24 carries a number of fluid deflection plates 26 which are dispersed over the length of the center piece 10 of the sheathing tube and have a shape, orientation, and perforation in correspondence to the perforated base 22 but are less thick and do not occupy the entire cross section of the end piece 12 but have recesses oriented alternatingly in opposite directions.

A number of unillustrated internal tubes in correspondence to a number of holes in the perforated bases 22 and the fluid deflection plates 26 extend from one perforated base 22 to the other. The ends of the internal tubes, which may also be hoses, are in alignment with the axial outer surfaces of the perforated bases 22 and are welded on the outer sides of the perforated bases 24 in fluid-tight manner with the perforated bases 22.

The internal tubes and the perforated bases 24 separate a first fluid space bounded by the inner surface of the center piece 10 of the sheathing tube and the outer surfaces of the internal tubes, from a second fluid space bounded from the inner surfaces of the internal tubes, the end pieces 12, and the end caps 16. In use, on one hand, a first fluid, a liquid and/or gaseous cooling or heating medium, flows from one of the connection pipes 14 through the first fluid space to the other connection pipe 14, and, on the other hand, a second fluid, a liquid and/or gaseous cooling or heating medium to be cooled or heated, flows in counterflow to the first fluid from the one connection pipe 18 through the second fluid space to the other connection pipe 18. The alternatingly arranged fluid deflection plates 26 generate cross-currents of the first fluid to realize a particularly good flow around the internal tubes.

As can be seen in FIGS. 1a to 1e, the end pieces 12, except for their ring-shaped end faces where they are welded to the center piece 10 and the pertaining end cap 16, have a greater outer diameter and a greater wall thickness than the center piece 10 and the end caps 16 of the sheathing tube. These greater dimensions are utilized for cross sectional expansions in an area where the inflow and outflow ports of the connection pipes 14 connect into the interior of the end pieces 12 so that the internal tubes are exposed to less stress by the first fluid. Moreover, the greater dimensions enhance the strength of the end pieces 12 and more than compensate their mechanical weakening as a result of the presence of greater inflow and outflow ports. Furthermore, the wider end pieces 12 provide the connection pipes 14 with added support.

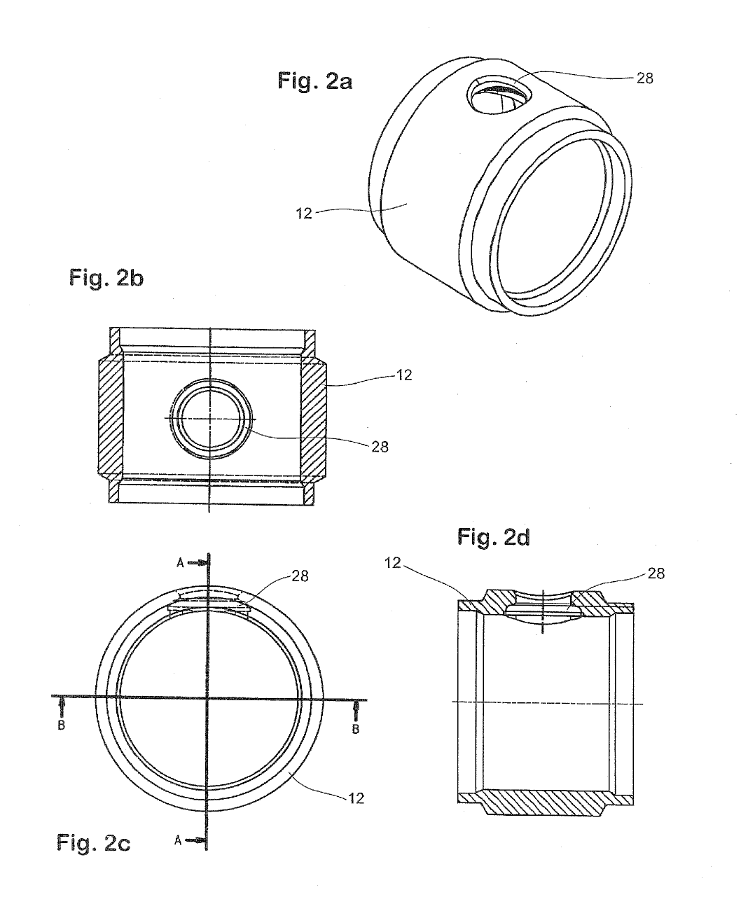

FIGS. 2a to 2d show one of the end pieces 12 of the tubular heat exchanger shown in FIGS. 1a to 1e on an enlarged scale. This end piece 12, as shown here, is manufactured e.g. through injection molding, and then welded to a connection pipe 14, the center piece 10 and the pertaining end cap 16. Clearly illustrated is the enlargement of the diameter and the wall thickness over an axial zone in the area of an opening 28 for the connection pipe 14 as well as the cross sectional expansion of the opening 28 towards the interior of the end piece 12.

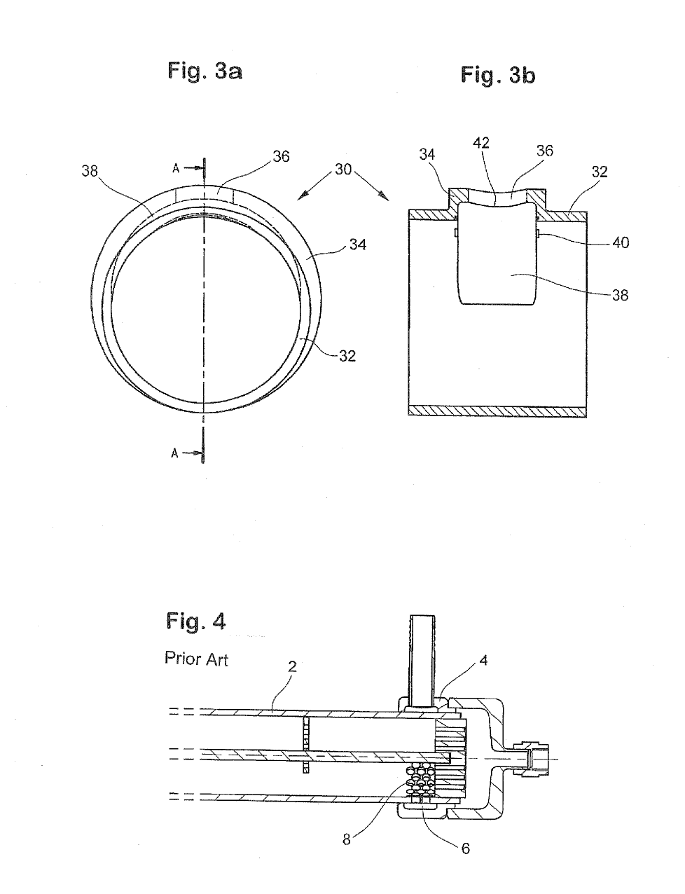

In a second exemplary embodiment, a heat exchanger has basically a same configuration as in the exemplary embodiment according to FIGS. 1a to 1e, however the two end pieces 12 are replaced by two end pieces 30 of which one is shown in FIGS. 3a and 3b.

Each end piece 30, made e.g. by injection molding, includes a cylindrical base 32 having a circumference formed with a protrusion 34 which extends axially over a greater distance than the diameter of an opening 36 for a connection pipe, not shown here, similar to the connection pipe 14 in FIGS. 1a to 1e and extends radially about the end piece 30 and thus becomes continuously more shallow so that the protrusion 34 has a sickle-shaped configuration. The protrusion 34 forms a partial enlargement of the diameter and wall thickness of the cylindrical base 32 so that the latter is not only stiffened but room is also created for accommodation and securement of a baffle plate 38 whose contours are indicated in FIG. 3a by broken line. The opening 36 which extends through the cylindrical base 32 and the sickle-shaped protrusion 34 is shaped to conform to the inner diameter of the connection pipe to be welded on.

The baffle plate 38 is made from an elongated rectangular plastic board, bent along its length into a semicircle with a smaller radius than the radius of the end piece 30, and has small projections 40 by which the baffle plate 38 is pushed lengthwise into unillustrated retention grooves which are formed axially in front of and behind an opening 34 in the end piece 30 and also bent like the baffle plate 38.

The baffle plate 38 forms a fluid guide structure situated anteriorly of the opening 36 and disperses fluid flowing into the opening 36 laterally about the circumference of the end piece 30. The baffle plate 38 has a chamfer 42 which is disposed in confronting relation to the opening 36 and extends over part of the length of the baffle plate 38 to promote or enable the radial fluid flow.

The described exemplary embodiments may also be combined by realizing cross sectional expansions of the fluid opening as well as also of a baffle plate or the like anteriorly of the fluid opening as fluid guide structures.

In a third exemplary embodiment, a tubular heat exchanger has basically a similar configuration as in the exemplary embodiment according to FIGS. 1a to 1e, however one of the end pieces 12 or both end pieces 12 is/are replaced by one end piece 50 or two end pieces 50, respectively, as shown in FIGS. 5a and 5b.

In this third exemplary embodiment, the two axial ends of the end piece 50 do not have the same diameter, as shown in the previous exemplary embodiments, but have different diameters, as can be seen in FIG. 5b. This means that the sheathing tube and the end caps do not need to have the same diameter but they may have different diameters, so that the end piece 50 can be conformed to the diameter. The difference in diameter may even be greater than illustrated in FIG. 5b. Moreover, such a difference in diameter may also be realized in the afore-described exemplary embodiments.

In contrast to the previous exemplary embodiments, the end piece 50 shown in FIGS. 5a and 5b has an additional conical connection pipe 52 which expands towards the interior of the end piece 50. Accommodated within the conical connection pipe 52 is a distributor cage 54, i.e. a cage-like element with several longitudinal slots in its wall. The distributor cage 54 forms a fluid guide structure which disperses fluid introduced through the connection pipe 52 via part of the circumference of the end piece 50 or collects fluid outflowing from there through the connection pipe.

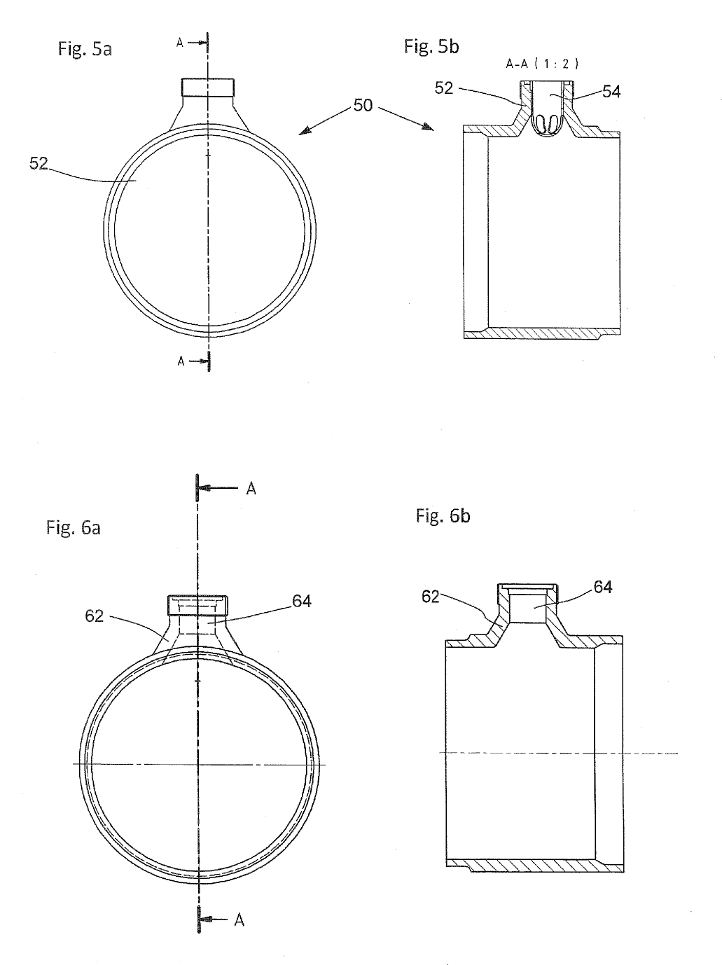

In a fourth exemplary embodiment, shown in FIGS. 6a and 6b, an end piece 60 of a tubular heat exchanger, like in the third exemplary embodiment, has ends of different diameters and has also a conical connection pipe 62 which widens towards the interior of the end piece 60. However, there is no distributor cage in the connection pipe 62 but rather an exchangeable filter 64 as safety dirt collector.

The third and fourth exemplary embodiments may also be combined with one another by providing a distributor cage as well as a filter in the connection pipe. Further, these exemplary embodiments may also be combined with the first and second exemplary embodiments.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A tubular heat exchanger, comprising:
a substantially cylindrical sheathing tube having a center piece and two end pieces of a length which is shorter than a length of the center piece;
two perforated bases received in the end pieces in one-to-one correspondence and sized to occupy a cross section thereof;
two end caps secured to axial ends of the end pieces in one-to-one correspondence;
a plurality of internal tubes extending in substantial parallel relationship inside the sheathing tube between the perforated bases to thereby define a first fluid space between an inner surface of the sheathing tube and outer surfaces of the internal tubes, and a separate second fluid space bounded by inner surfaces of the internal tubes and the end caps on the end pieces; and
two lateral connection pipes secured to the end pieces in one-to-one correspondence and fluidly communicating with the first fluid space in a region adjacent to the perforated bases for supply and drainage, respectively, of a first fluid flowing through the first fluid space,
wherein the end pieces constitute separate parts which are welded with their axial ends to opposite ends of the center piece and to the end caps.

2. The tubular heat exchanger of claim 1, wherein the sheathing tube, perforated bases, end caps, internal tubes, and connection pipes are all made of plastic.

3. The tubular heat exchanger of claim 1, wherein at least one of the end pieces has at least an area of greater outer diameter and/or greater wall thickness than the center piece of the sheathing tube.

4. The tubular heat exchanger of claim 1, further comprising a fluid guide structure received in at least one of the end pieces to route fluid introduced or outflowing through a respective one of the connection pipes at least partly over a circumference of the end piece.

5. The tubular heat exchanger of claim 4, wherein the fluid guide structure includes a baffle plate which covers at least part of an inner cross section of the connection pipe.

6. The tubular heat exchanger of claim 5, wherein the baffle plate is made of plastic and has an elongated rectangular configuration which is bent along its length to a part circle with a radius that is smaller than a radius of the end piece.

7. The tubular heat exchanger of claim 6, wherein the baffle plate has longitudinal edges provided with projections which engage in bent retention grooves formed in the end piece in a region of the connection pipe.

8. The tubular heat exchanger of claim 1, further comprising a distributor cage arranged in at least one of the connection pipes and acting as a fluid guide structure.

9. The tubular heat exchanger of claim 1, further comprising a filter arranged in at least one of the connection pipes and acting as a safety dirt collector.

10. A method for producing a tubular heat exchanger, comprising the steps of:
making a substantially cylindrical center piece of plastic;
making two end pieces of plastic, each having a length which is smaller than a length of the center piece;
welding a connection pipe of plastic to each of the end pieces;
placing in each of the end pieces adjacent to the connection pipe a perforated base of plastic which is sized to occupy a cross section thereof;
inserting a plurality of internal plastic tubes in substantial parallel relationship between the perforated bases in the end pieces;
welding to each axial end of the end piece a plastic end cap;
welding the end pieces to opposite axial ends of the center piece to form a sheathing tube to thereby define a first fluid space between an inner surface of the sheathing tube and outer surfaces of the internal tubes, and a separate second fluid space bounded by inner surfaces of the internal tubes and the end caps on the end portions.

11. The method of claim 10, wherein the welding steps are realized through an infrared welding process.

12. The method of claim 10, wherein at least one end piece before being welded to the center piece, is formed with at least an area of greater outer diameter and/or greater wall thickness than the center piece.

13. The method of claim 10, further comprising the step of placing a fluid guide structure in at least one of the end pieces before being welded to the center piece to route fluid introduced or outflowing through a respective one of the connection pipes at least partly over a circumference of the end piece.

14. The method of claim 13, wherein the fluid guide structure is a baffle plate in the form of an elongated rectangular plastic board which is bent along its length to a part circle with a smaller radius than a radius of the end piece and which is provided along its longitudinal edges with projections with which the baffle plate is pushed lengthwise in bent retention grooves which are formed in the end piece in the region of the connection pipe so that the baffle plate covers at least part of an inner cross section of the connection pipe.

15. The method of claim 10, further comprising the step of placing at least one member selected from the group consisting of a distributor cage as fluid guide structure and a filter as safety dirt collector in at least one of the connection pipes.
